(19) United States
(12) Patent Application Publication
(10) Pub. No.: US 2017/0227224 A1
(43) Pub. Date: Aug. 10, 2017

(54) FUEL INJECTOR FOR COMBUSTION ENGINE SYSTEM, AND ENGINE OPERATING METHOD

(71) Applicant: Solar Turbines Incorporated, San Diego, CA (US)

(72) Inventors: Gareth Oskam, San Diego, CA (US); Ricardo Aleman, San Diego, CA (US)

(73) Assignee: Solar Turbines Incorporated, San Diego, CA (US)

(21) Appl. No.: 15/019,239

(22) Filed: Feb. 9, 2016

(51) Int. Cl. F23R 3/28; B05B 1/34; F02C 7/22

(52) U.S. Cl. CPC F23R 3/286; F02C 7/222; B05B 1/3478; F05D 2220/30

(57) ABSTRACT

A fuel injector for a combustion engine includes an injector body having formed therein a first passage structured to feed a fuel to an outlet of the injector body, and a second passage structured to feed air to the outlet of the injector body. Flow-directing surfaces are exposed to a flow of fuel through the first passage to induce swirl, and a flow segregator is positioned between the flows of fuel and air such that the air shrouds the swirling flow of fuel and inhibits migration of fuel radially outwardly from the fuel injector outlet.

### TECHNICAL FIELD

The present disclosure relates generally to the field of combustion engines, and more particularly to fuel injection apparatus for a combustion engine having structure for directing flows of fuel and air during fuel injection.

### BACKGROUND

Known fuel delivery mechanisms for combustion engines have many forms. In the case of gas turbine engines, a fuel injector is commonly positioned so as to deliver a fuel such as a gaseous fuel, a liquid fuel, or mixtures directly into the combustor. The injected fuel ignites with pressurized air within the combustor to provide motive power to the turbine in a well-known manner. Known gas turbine engine fuel injectors may have one, two, or more flow passages structured to deliver one or more fuels, air, and mixtures of fuel(s) and air. Commonly owned U.S. Pat. No. 9,182,124 to Oskam sets forth one example fuel injector in a gas turbine engine.

It is generally desirable to mix fuel and air in the combustion space of an engine as thoroughly as practicable in the interests of efficiency and emissions levels. In at least certain applications it can be desirable to initiate such mixing of the fuel and air prior to exiting the fuel injector. To this end, flows of fuel and air are sometimes merged within the fuel injector and discharged from a common outlet of the fuel injector. Some known systems have drawbacks relative to certain applications.

### SUMMARY

In one aspect, a fuel injector includes an injector body defining a fuel inlet, an air inlet, and an outlet, and the injector body further defines a first passage extending between the fuel inlet and the outlet, and a second passage extending between the air inlet and the outlet. The injector body further includes flow-directing surfaces exposed to a flow of fuel through the first passage and structured to induce a swirl in the flow of fuel exiting the outlet. The first passage feeds the outlet from inward locations, and the second passage feeds the outlet from outward locations, such that air fed to the outlet by way of the second passage shrouds the swirling flow of the fuel exiting the outlet.

In another aspect, a combustion engine system includes an engine housing defining a combustion space, a fuel supply, and a fuel injector including an injector body defining a longitudinal axis, and having an outlet in fluid communication with the combustion space, and the injector body defining a fuel inlet in fluid communication with the fuel supply, an air inlet, and an outlet. The injector body further defines a first passage extending between the fuel inlet and the outlet, and a second passage extending between the air inlet and the outlet. The injector body further includes flow-directing surfaces exposed to a flow of fuel through the first passage and structured to induce a swirl in the flow of fuel exiting the outlet, and wherein the first passage feeds the outlet from a first location axially inward of the outlet and the second passage feeds the outlet from an adjacent location axially inward of the outlet.

In still another aspect, a method of operating an engine includes conveying a fuel through a first passage in a fuel injector that feeds an outlet of the fuel injector in fluid communication with a combustion space in the engine, and discharging the fuel from the outlet into the combustion space. The method further includes inducing swirl in a flow of the fuel exiting the outlet, and conveying air into a second passage within the fuel injector that feeds the outlet at locations surrounding the first passage, such that the air shrouds the swirling flow of the fuel during discharging.

### BRIEF DESCRIPTION OF THE DRAWINGS

FIG. 1 is a diagrammatic view of a combustion engine, according to one embodiment;

FIG. 2 is a sectioned side diagrammatic view of a portion of the combustion engine of FIG. 1;

FIG. 3 is a sectioned diagrammatic view through a portion of a fuel injector, according to one embodiment; and

FIG. 4 is a sectioned side diagrammatic view through a portion of a fuel injector, according to one embodiment.

### DETAILED DESCRIPTION

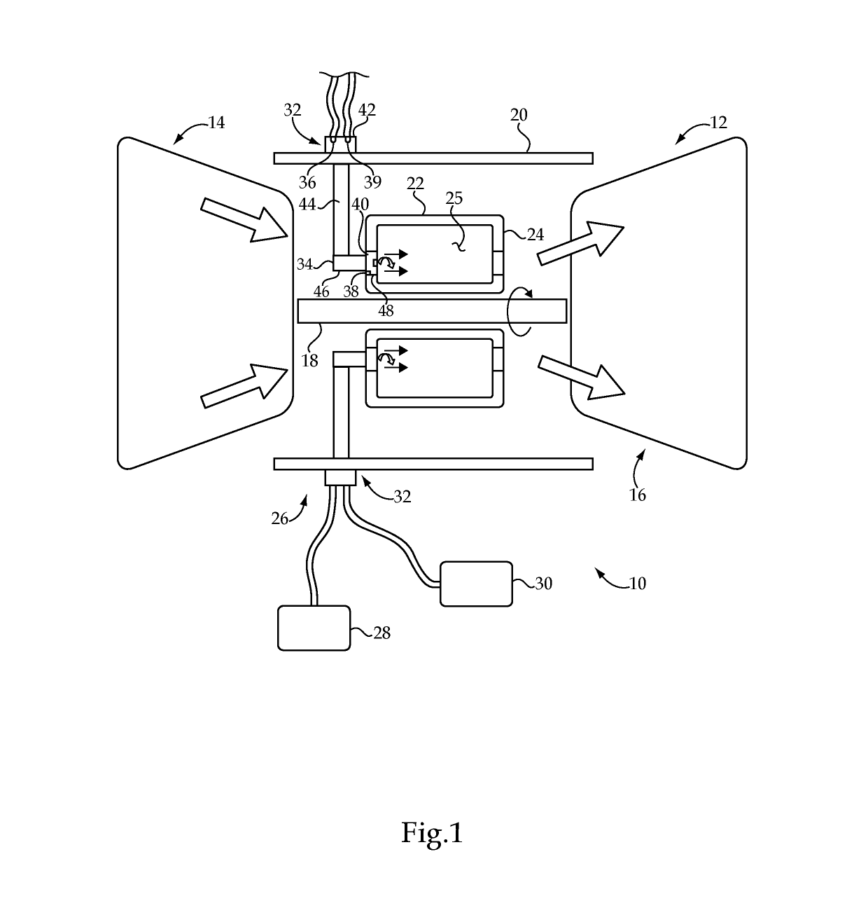

Referring to FIG. 1, there is shown an engine system 10 including a combustion engine 12. Engine 12 is shown in the context of a gas turbine engine having a compressor 14 and a turbine 16, coupled together by way of a shaft 18. Compressor 14 compresses air by way of rotation, and supplies the compressed air to a combustor 20, from which expanding gases from combustion of fuel with the compressed air are conveyed to turbine 16 to drive turbine 16 and compressor 14 in a well-known manner. Engine system 10 further includes a fuel system 26 that may include a supply of gaseous fuel 28 and a supply of liquid fuel 30. Those skilled in the art will appreciate that a wide variety of gaseous fuels such as natural gas, methane, propane, landfill gas, hydrogen-rich gas mixtures and still others could be used. Likewise, the liquid fuel could be diesel, biodiesel, kerosene, etc. Apparatus such as an evaporator for converting stored liquid flammables such as liquid natural gas to vapor could also be provided. Embodiments are contemplated where only one of a gaseous fuel or a liquid fuel is used. Fuel system 26 will typically be capable of providing at least a gaseous fuel to combustor 20. Combustor 20 may also include a housing or pressure casing 22, and a liner 24 that defines a combustion space 25. In a practical implementation strategy, fuel system 26 further includes a plurality of fuel injectors 32 structured to supply fuel directly into combustion space 25. As the plurality of fuel injectors will typically be interchangeable, the present description of a single fuel injector should be understood to refer to any of the fuel injectors in engine 12. As will be further apparent from the following description, fuel injector 32 is uniquely configured to provide for mixing of fuel with air and for tailoring and control of various properties of the flow of fuel and air injected into combustor 20. In FIG. 1 the curved arrows shown exiting fuel injector(s) 32 indicate the swirling fuel, flanked by solid arrows indicating air flowing alongside and shrouding the swirling fuel as the fuel and air enter combustion space 25. It should be appreciated that the flow of air shrouding the swirling fuel might be swirling in the same direction as the fuel, a counter-direction, or not swirling substantially at all.

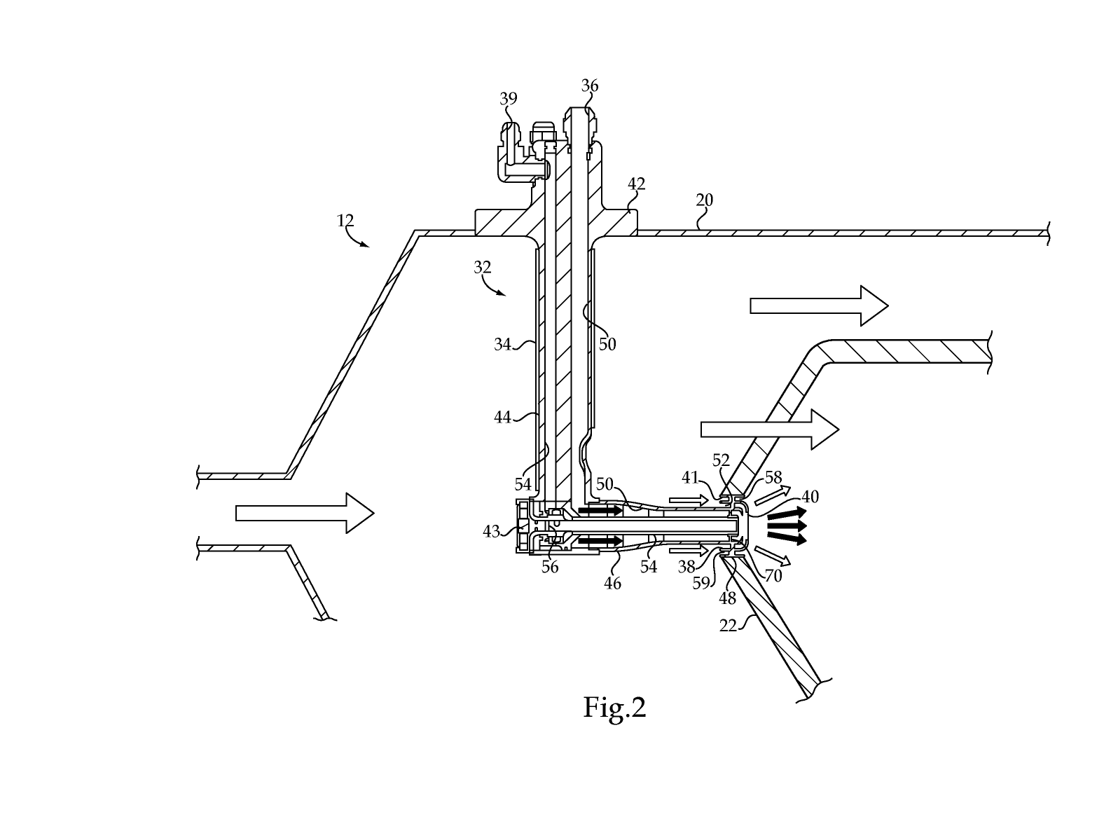

Referring also now to FIG. 2, in the illustrated embodiment fuel injector 32 includes an injector body 34 defining a first fuel inlet 36, which may be a gaseous fuel inlet connected to fuel supply 28, a second fuel inlet 39 that may be a liquid fuel inlet connected to fuel supply 30, and an air inlet 38. Injector body 34 may also define a second air inlet 41 and a third air inlet 43, and an outlet 40. Injector body 34 also defines a first passage 50 extending between fuel inlet 36 and outlet 40, and a second passage 52 extending between air inlet 38 and outlet 40. Injector body 34 also includes flow-directing surfaces 70 exposed to a flow of fuel such as gaseous fuel through first passage 50 and structured to induce a swirl in the flow of fuel exiting outlet 40. It can further be noted that first passage 50 feeds outlet 40 from radially inward locations and second passage 52 feeds outlet 40 from radially outward locations. Injector 32 may also be understood as structured so that first passage 50 feeds outlet 40 from a first location axially inward of outlet 40 and second passage 52 feeds outlet 40 from a second location axially inward of outlet 40. The structure of injector 32 and positioning of the feed locations as described can enable desirable properties in the flows of fuel and air as further described herein.

As noted above, injector body 34 may define a second air inlet 41, and may further define a second outlet 58. A third passage 59 extends between inlet 41 and outlet 58 and is structured to feed air into combustion space 25 in parallel with fuel and air from outlet 40. As also shown in FIGS. 1 and 2, injector body 34 may include a flange or flange portion 42, a stem or stem portion 44, a head or head portion 46, and a tip or tip portion 48. Embodiments are contemplated where these components are separate assembled pieces as well as where two or more such components are formed integrally. Additive manufacturing such as so-called 3D printing or the like could be used to form one or more of the components of injector 32, although the present disclosure is not thereby limited. It can be noted that air inlet 38 is generally annular and defined in part by head portion 46 and in part by tip portion 48.

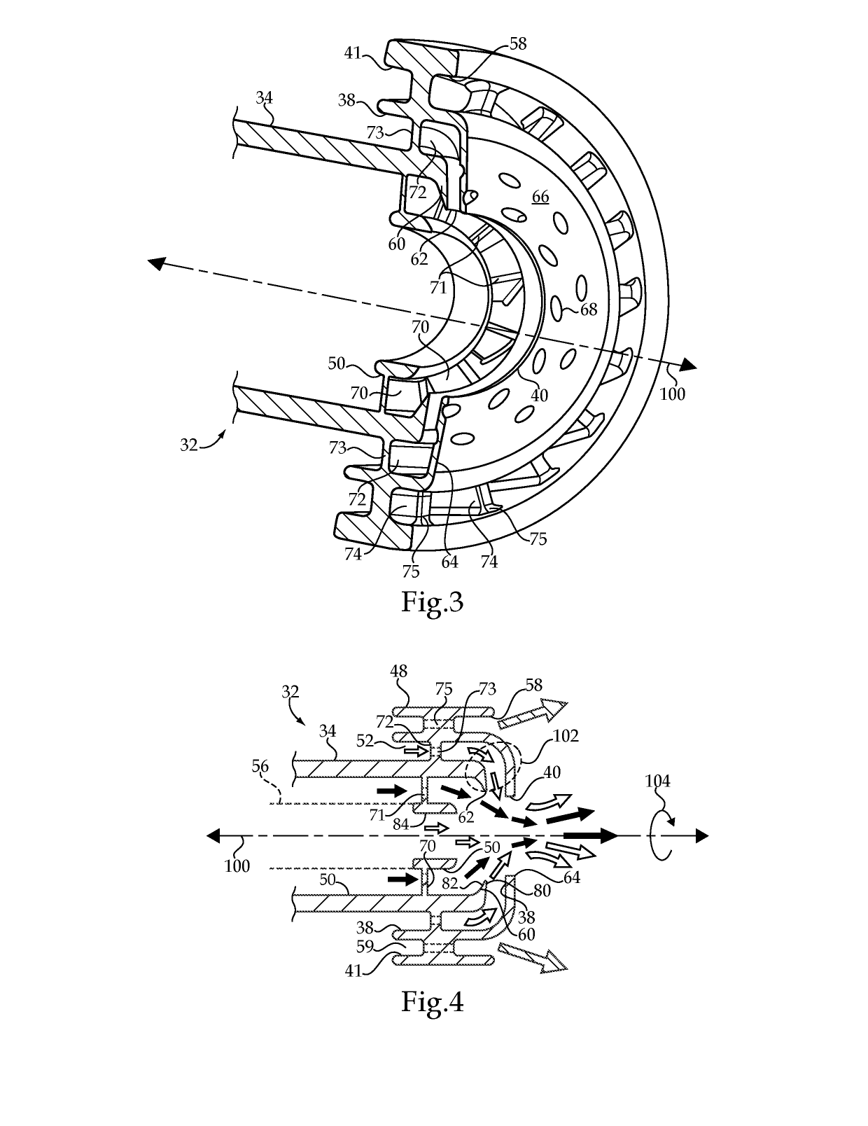

Referring also now to FIG. 3, as noted above injector body 34 may include flow-directing surfaces 70 exposed to a flow of fuel through passage 50. Injector body 34 may further include flow-directing surfaces 72 exposed to a flow of air through passage 52, and flow directing surfaces 74 exposed to a flow of air through passage 59. In a practical implementation strategy, flow-directing surfaces 70, 72, and 74 may be positioned within passages 50, 52 and 59, and located upon flow-directing vanes 71, 73, and 75. Passages 50, 52 and 59 may be coaxial. As alluded to above, feed locations of passages 50 and 52 to outlet 40 may be such that flows of fuel and air merge prior to exiting outlet 40 and some mixing of the fuel and air commences prior to injection. Liquid fuel may be conveyed through injector body 34 by way of a liquid fuel passage 54 that connects with inlet 39. A liquid fuel metering apparatus 56 may also be positioned within injector body 34 and is structured to supply liquid fuel into a flow of gaseous fuel through passage 50. Liquid fuel could be delivered by way of a different strategy, or not at all. Injector body 34 also includes a terminal tip 64 that defines outlet 40. In the illustrated embodiment terminal tip 64 has a dome shape and outlet 40 is centered within the dome shape, although the present disclosure is not thereby limited. Still another air inlet 43 may be formed in injector body 34 that enables compressed air to be fed through injector body 34 and generally through a center cavity (not numbered) with passages 50, 52, 54, and 59 extending circumferentially around the center cavity to the extent there is axial overlap therewith. Arrows in FIG. 2 denote example air flow and fuel flow patterns, with those arrows originating closest to outlet 40 and arrows within fuel injector 32 itself indicating fuel flow. Still other structures of injector body 34 may facilitate desired flow properties and mixing of fuel(s) and air.

To this end, fuel injector 32 may further include a flow segregator 60 segregating the flows of fuel and air feeding outlet 40. Flow segregator 60 may have the form of a protruding wall extending circumferentially around longitudinal axis 100 and being positioned such that terminal tip 64 is spaced axially outward of flow segregator 60. Referring also now to FIG. 4, an example inwardly curved profile and taper of flow segregator 60 is evident. Also shown in FIG. 4 is an edge 62 of flow segregator 60 that is formed by the taper of flow segregator 60 and defines a confluence of the flows of fuel and air feeding outlet 40. An outer surface 80 and an inner surface 82 of flow segregator 60 intersect at edge 62. In a practical implementation strategy, edge 60 is substantially circular and extends circumferentially around longitudinal axis 100 so as to form a circular opening centered on longitudinal axis 100.

### INDUSTRIAL APPLICABILITY

During operating engine 12 fuel is conveyed through first passage 50 so as to feed outlet 40, and thenceforth discharges into combustion space 25 fluidly connected with outlet 40. Just prior to discharging, the flow of fuel interacts with flow-directing surfaces 70 to induce a swirl in the flow as it exits outlet 40. Inducing swirl has been demonstrated to be associated with improved mixing of fuel with air for combustion, and hence improvements in flame stability and certain emissions levels and improvements in efficiency as compared to not swirled designs. Air is conveyed into second passage 52 within fuel injector 32 so as to feed outlet 40 with the air and discharge the air into combustion space 25. As discussed above, outlet 40 may be fed at locations adjacent to and surrounding passage 50 such that the air shrouds the swirling flow of the fuel during discharging.

It has been observed in certain gas turbine engines that injected fuel can migrate, apparently due to the formation of eddies, outwardly from an injector tip. In fuel injectors having certain similarities to fuel injector 32, fuel is suspected to travel outwardly from the outlet along the surface of the tip exposed to the combustion space. The migrating fuel can burn, potentially incompletely, in close proximity to the surface of the fuel injector tip and ultimately result in undesired heating and/or damage to material of the injector tip and potentially deposition of carbon material thereon. In certain instances, deposited carbon material can later dislodge and have undesired effects downstream. The present disclosure is contemplated to overcome these and other disadvantages in that migration of fuel outwardly in the manner described is limited or eliminated altogether. Instead, the air shrouding the fuel flow assists the swirling fuel in traveling out of and away from the injector tip and limits the tendency for the fuel to travel outward and form eddies promoting migration along injector tip surfaces. As shown in FIG. 3, holes 68 through tip end surface 66 may be provided so as to enable some air flow through terminal tip 64 to assist in the limiting of fuel migration and/or assist in urging migrating fuel away from surface 66. Other surface features or texturing could be formed on terminal tip 64 for such purposes, and embodiments are contemplated where no surface features, holes, etc. are needed at all.

In FIG. 4 arrow 104 identifies an example swirl direction of the fuel, shown via solid arrows. It will be appreciated that swirl will typically commence approximately where the flow of fuel impinges upon flow-directing surfaces 70. While flow-directing vanes provide a practical implementation strategy, in other instances holes or still another flow-directing structure might be used. It will also be noted that vanes 71, 73, 75 are illustrated as having generally similar pitch, spacing and size. Vanes 71, 73, 75 are also tilted in the same direction as one another so as to induce swirling of fuel and air in the same directions, e.g. all inducing swirl clockwise or all inducing swirl counter-clockwise, about longitudinal axis 100. These factors including vane size, pitch, spacing, and other characteristics are controllable factors that can be varied to produce different gas and/or fuel flow characteristics. For instance, rather than inducing swirl in fuel and air from passages 50 and 52 in the same direction the swirling could be in opposite directions, potentially introducing or increasing shearing between the adjacent flows or having other effects. It is also contemplated that the sizes and relative sizes of various features such as outlet 40 versus a center opening 84 can also be varied. It can also be seen in FIG. 4 that a region 102 is identified that is just upstream of edge 62 and within passage 52. Those skilled in the art will appreciate the relatively high flow rates that are often desired for fuel of relatively low calorific value such as certain gaseous fuels and gaseous fuel blends. In certain prior designs an aerodynamic blockage may occur at locations analogous in such prior designs to region 102 that could prevent or limit flow of air for mixing with the flow of fuel. Flow segregator 60 can be understood to segregate flows of fuel and air, as well as defining a confluence of the flow of fuel so as to facilitate a relatively smooth merging of the fuel and air flows and limit aerodynamic blockage of the nature described above. It should further be appreciated that certain features of flow segregator itself can also be understood as controllable variables, including the shape and sharpness of edge 62, the inclination and/or curvature of surfaces 80 and 82, for instance.

The present description is for illustrative purposes only and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. A fuel injector comprising:
an injector body defining a fuel inlet, an air inlet, and an outlet, and the injector body further defining a first passage extending between the fuel inlet and the outlet, and a second passage extending between the air inlet and the outlet;
the injector body further including flow-directing surfaces exposed to a flow of fuel through the first passage and structured to induce a swirl in the flow of fuel exiting the outlet; and
the first passage feeding the outlet from inward locations, and the second passage feeding the outlet from outward locations, such that air fed to the outlet by way of the second passage shrouds the swirling flow of the fuel exiting the outlet.

2. The fuel injector of claim 1 further comprising a flow segregator segregating the flows of fuel and air feeding the outlet.

3. The fuel injector of claim 2 wherein the injector body defines a longitudinal axis, and the flow segregator has the form of a protruding wall extending circumferentially around the longitudinal axis.

4. The fuel injector of claim 3 wherein the injector body includes an injector terminal tip having a dome shape and defining the outlet, and the injector terminal tip being spaced axially outward of the flow segregator.

5. The fuel injector of claim 4 wherein the protruding wall has a taper so as to form an edge defining a confluence of the flows of fuel and air feeding the outlet.

6. The fuel injector of claim 1 wherein the flow-directing surfaces are located upon a plurality of vanes positioned within the first passage.

7. The fuel injector of claim 1 wherein the injector body includes a head portion, and a tip portion, and the air inlet is annular and defined in part by the head portion and in part by the tip portion.

8. The fuel injector of claim 7 wherein the injector body has a second air inlet formed therein and a second outlet, and defines a third passage extending between the second air inlet and the second outlet.

9. The fuel injector of claim 8 further comprising flow-directing surfaces within the second passage and flow-directing surfaces within the third passage, and wherein the first passage, the second passage, and the third passage are coaxial.

10. The fuel injector of claim 9 wherein the flow-directing surfaces within each of the first passage, the second passage, and the third passage are located upon flow-directing vanes.

11. A combustion engine system comprising:
an engine housing defining a combustion space;
a fuel supply;
a fuel injector including an injector body defining a longitudinal axis, and having an outlet in fluid communication with the combustion space, and the injector body defining a fuel inlet in fluid communication with the fuel supply, an air inlet, and an outlet;
the injector body further defining a first passage extending between the fuel inlet and the outlet, and a second passage extending between the air inlet and the outlet;
the injector body further including flow-directing surfaces exposed to a flow of fuel through the first passage and structured to induce a swirl in the flow of fuel exiting the outlet, and wherein the first passage feeds the outlet from a first location axially inward of the outlet and the second passage feeds the outlet from an adjacent location axially inward of the outlet.

12. The engine system of claim 11 comprising a gas turbine engine system.

13. The engine system of claim 12 wherein the fuel injector further includes an injector tip portion defining a second air inlet and a second outlet, and a third passage extending between the second air inlet and the second outlet.

14. The engine system of claim 13 wherein the injector body further includes flow-directing surfaces exposed to a flow of air through the second passage, and flow-directing surfaces exposed to a flow of air through the third passage.

15. The engine system of claim 14 wherein the first passage, the second passage, and the third passage are coaxial.

16. The engine system of claim 11 wherein the injector further includes a terminal tip having a dome shape and defining the outlet, and a flow segregator separating the flows of fuel and air feeding the outlet.

17. The engine system of claim 16 wherein the flow segregator includes a protruding wall extending circumferentially around the longitudinal axis and being tapered so as to form an edge defining a confluence of the flows of fuel and air.

18. A method of operating an engine comprising:
conveying a fuel through a first passage in a fuel injector that feeds an outlet of the fuel injector in fluid communication with a combustion space in the engine;
discharging the fuel from the outlet into the combustion space;
inducing swirl in a flow of the fuel exiting the outlet; and
conveying air into a second passage within the fuel injector that feeds the outlet at locations surrounding the first passage, such that the air shrouds the swirling flow of the fuel during discharging.

19. The method of claim 18 wherein the engine is a gas turbine engine and the fuel is a gaseous fuel, and wherein inducing swirl includes inducing swirl by way of flow-directing vanes within the first passage.

20. The method of claim 19 further comprising limiting migration of the fuel in a radially outward direction from the outlet by way of the shrouding of the fuel during discharging.
